(19) United States
(12) Patent Application Publication
(10) Pub. No.: US 2026/0146682 A1
(43) Pub. Date: May 28, 2026

(54) Freeze-Safe Heat Pipe Valve Stem

(71) Applicant: National Technology & Engineering Solutions of Sandia, LLC, Albuquerque, NM (US)

(72) Inventor: Matthew David Carlson, Highlands Ranch, CO (US)

(21) Appl. No.: 19/453,243

(22) Filed: Jan. 20, 2026

Related U.S. Application Data
(63) Continuation of application No. 17/152,415, filed on Jan. 19, 2021, now abandoned.
(60) Provisional application No. 62/963,301, filed on Jan. 20, 2020.

(51) Int. Cl. F16K 49/00; F16K 41/10; F28D 15/02

(52) U.S. Cl. CPC F16K 49/005; F16K 41/10; F28D 15/0275

(57) ABSTRACT

Valves that include a hollow valve stem with an internal heat transfer fluid that naturally circulates within the stem acts as a heat pipe to the valve bonnet to prevent fluid within the valve from freezing. This approach protects the valve body, stem, bonnet and sealing material such as valve packing or a bellows from being damaged by frozen fluid at any location within the valve.

### RELATED APPLICATION

This application is a continuation of U.S. patent application Ser. No. 17/152,415, filed Jan. 19, 2021, entitled “Freeze-Safe Heat Pipe Valve Stem,” which claims priority to U.S. Provisional Application No. 62/963,301, filed on Jan. 20, 2020, entitled “Freeze-Safe Heat Pipe Stem”, in which both are incorporated herein by reference in their entireties.

### STATEMENT REGARDING FEDERALLY SPONSORED RESEARCH OR DEVELOPMENT

This invention was developed under Contract No. DE-NA0003525 awarded by the United States Department of Energy/National Nuclear Security Administration. The Government has certain rights in this invention.

### FIELD

The present disclosure is generally directed to valves, and more particularly to valves that incorporate a heat pipe to resist valve freezing.

### BACKGROUND OF THE INVENTION

Conventional industrial valves feature a valve seat which controls the flow of some working fluid, a valve body which routes flow to and from the valve seat, a valve bonnet which seals the working fluid in the system around a valve stem using some packing material or a bellows, and a valve actuation mechanism connected to the valve stem which overcomes the pressure and frictional forces within the valve body between the valve seat and the flow control mechanism (globe tip, plug, gate, etc.).

High temperature piping systems such as those used for molten salt or liquid sodium systems conventionally employ direct or indirect trace heating, such as direct resistance heating or induction heating, along the piping to prevent the fluid within the piping from freezing due to heat loss through the pipe insulation to ambient temperature conditions. Such systems are required because the freezing temperature of the fluid is generally higher than can be achieved by another trace heating fluid such as thermal oil or steam. These systems are also relatively simple because the thermal mass of the piping reduces the response time required of the active heating control system and there is minimal risk from differential thermal expansion.

High temperature valves such as those used for molten salt or liquid sodium systems often must employ an extended valve bonnet design in order to separate the valve packing and actuation mechanism from the valve body because these components typically must operate at lower temperatures than the working fluid. This offset poses a major challenge and potential risk for working fluids with high freezing temperatures because the working fluid has the potential to freeze within the extended valve bonnet packing or bellows which may permanently destroy the ability of the valve to actuate. This is due to the fact that heat can only be conducted axially through the extended bonnet and packing from the hot valve body to the cold actuation mechanism which enforces an axial thermal gradient along the valve body.

In order to avoid this, current extended bonnet designs employ complex heating and cooling systems along the valve bonnet to impose a specific temperature profile that maintains the working fluid in a liquid state without exceeding the operating temperature of the valve packing or bellows or freezing the working fluid in the packing. However, this system requires active heating elements and instrumentation to provide precise temperature feedback to maintain the specific temperature profile and avoid low temperatures which could freeze the working fluid, excessive thermal ramp rates which could cause differential thermal expansion of actuation components and prevent the valve from functioning, or high temperatures that could degrade the working fluid and valve materials.

FIG. 1 shows a prior art bellows-sealed valve (bellows valve) 10. The bellows valve 10 includes a valve body 12 and extended bonnet 14. The valve body 12 includes a seat 16. The extended bonnet 14 includes a bonnet body 15. Disposed within the extended bonnet 14 is valve stem 22 that includes a plug 24. In FIG. 1, the valve stem 22 is lowered and in a closed position that brings the plug 24 in contact with the valve seat 16 of the valve body 12. In this position, a fluid flow indicated by the arrow 25 is stopped at the plug 24 from continuing to flow through the valve body 12. Within the bonnet body 15 is a bellows 26 that surrounds the valve stem 22. Between the bellows 26 and the bonnet body 15 is bonnet space 28. The bellows 26 prevents fluids including gases, vapors and liquids that have leaked around the valve stem 22 and into the bonnet space 28 from leaking past the stem 22 into any upper valve space 30. A bellows is used to allow the valve stem 22 to translate up to bring plug 24 out of the valve seat 16 and open a flow path in the valve body 12 while still preventing leakage into the upper valve space 30. Heat tape 32 may be used to prevent fluids from freezing in the upper valve space 30.

FIG. 2 shows a prior art packed valve 40. The packed valve 40 includes a valve body 42 and an extended bonnet 44. The valve body 42 includes a seat 46. The extended bonnet 44 includes a bonnet body 45. Disposed within the extended bonnet 44 is valve stem 48 that includes a plug 50. In FIG. 2, the valve stem 48 is lowered and in a closed valve position that brings the plug 50 in contact with the valve seat 46 of the valve body 42. In this position, a fluid flow indicated by the arrow 52 is stopped at the plug 50 from continuing to flow through the valve body 42. Within the extended bonnet 44, packing 54 surrounds the valve stem 48. Between the valve stem 48 and bonnet body 45 is bonnet space 56. The packing prevents fluids including gases, vapors and liquids that have leaked past the valve stem 48 and into the bonnet space 56 from leaking past the stem 48 into any upper valve space 58. Heat tape 60 may be used to prevent fluids from freezing in the upper valve space 58.

Referring to FIGS. 1 and 2, it can be seen how the flow of a freeze-prone fluid entering the valve body and flowing past the stem and up into the valve bonnet sealing mechanism, bellows or packing, may create operational difficulty should the fluid freeze. This is a particular challenge for molten salts which readily wick into tight spaces, but other freeze-prone fluids with high vapor pressure can also infiltrate the sealing region by evaporation and condensation.

What is needed is a valve that includes features that protect against the working fluid freezing the valve assembly and reducing valve performance and/or rendering the valve inoperable.

### BRIEF SUMMARY OF THE INVENTION

One embodiment of the present disclosure is a valve that includes a valve bonnet, a valve stem having a length disposed within the valve bonnet, a valve body that includes a flow passage and a valve seat into which the valve stem extends when the flow control valve is in a closed position thereby stopping flow of a system fluid through the valve body, and a heat transfer medium disposed in the chamber. The valve stem includes an internal chamber comprising an interior wall that extends axially along part of the length of the valve stem. The heat transfer medium is a fluid at a selected operating temperature of the flow control valve.

An advantage of the disclosed inventions is that the packing or bellows around an extended bonnet of a valve can be passively maintained at a specified temperature at or below the temperature of the valve body and above the freezing temperature of the fluid flowing through the valve that extends or leaks into the valve bonnet whenever the valve body is kept above the freezing temperature of the working fluid without external heating elements or instrumentation. The liquid being controlled by the valve around the valve stem can be stagnant, as in the case of a shut valve, or flowing, as in the case of an open valve, and still provide sufficient heat to the valve stem heat pipe provided the liquid is maintained above the freezing temperature.

Alternative exemplary embodiments relate to other features and combinations of features as may be generally recited in the claims.

### BRIEF DESCRIPTION OF THE DRAWINGS

The application will become more fully understood from the following detailed description, taken in conjunction with the accompanying figures, wherein like reference numerals refer to like elements, in which:

FIG. 1 shows a prior art bellows-sealed valve design.

FIG. 2 shows a prior art packing valve design.

FIG. 3 shows a bellows-sealed valve according to an embodiment of the disclosure.

FIG. 4 shows a packed valve according to another embodiment of the disclosure.

FIG. 5 shows details of the heat pipe within a valve stem according to an embodiment of the disclosure.

FIG. 6 shows details of the heat pipe within a valve stem according to another embodiment of the disclosure.

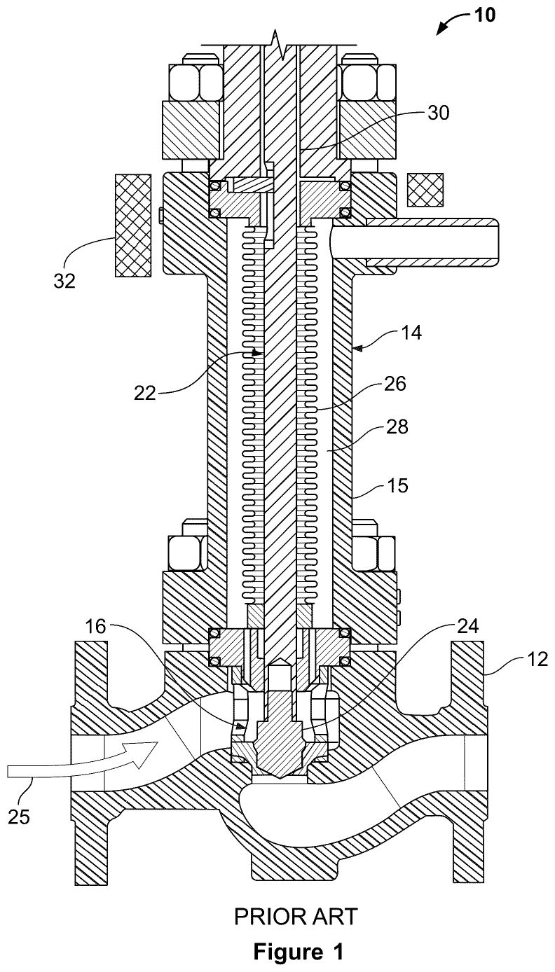

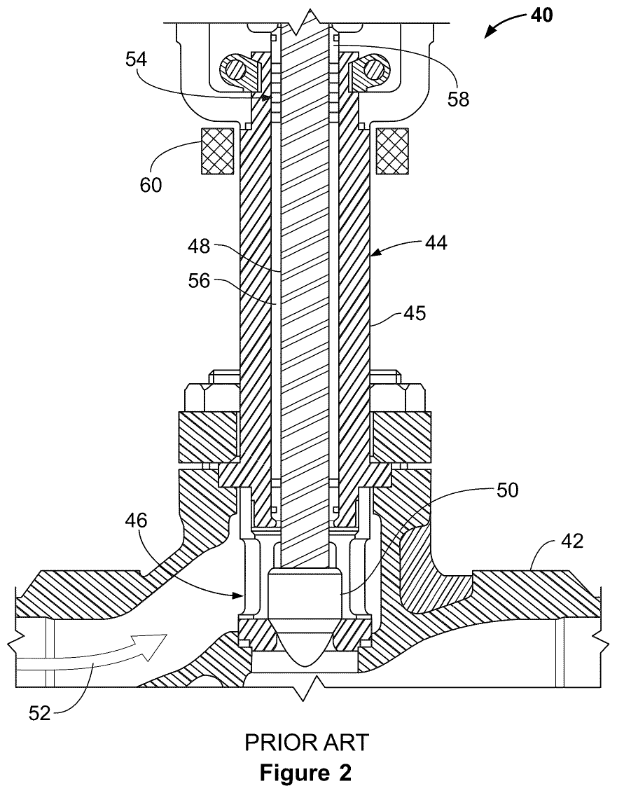

### DETAILED DESCRIPTION OF THE INVENTION

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

The present disclosure is directed to a valve, which may be referred to as “valve” herein for simplicity, including a hollow valve stem that includes a heat pipe containing an internal working fluid. The working fluid naturally circulates within the heat pipe and conducts heat to maintain a minimally-desired temperature gradient axially along the valve stem rather than allowing a large axial thermal gradient resulting from conduction alone that occurs in prior art designs. The temperature is based on the design and control of the heat pipe and fixed by the saturation pressure of the working fluid at operating temperatures. Hot conditions within the valve body heat the internal working fluid in a lower portion of the heat pipe, which can be referred to as an evaporator section, to a point where it evaporates. The subsequent vapor rises through the hollow heat pipe and condenses in an upper portion of the heat pipe, which can be referred to as a condenser section. The condenser section as well as the remainder of the heat pipe may include a wicking material that may assist the condensed fluid to travel back by capillary action and gravitation force to the evaporator section. In an embodiment, it was determined that the capillary wicking material may also be present when the valve is installed with the bonnet below the valve body where gravity opposes liquid return from the condenser to the evaporator.

The disclosed embodiments take advantage of the already-hot working fluid as a heat source and the penetration of the valve stem through the extended bonnet to maintain a minimal temperature gradient within the valve stem axially along the length of the packing material or bellows, thus avoiding temperatures in the bonnet below the freezing temperature of the fluid in the bonnet space. The outside of the extended bonnet can then be provided with only enough insulation to impose a lateral thermal gradient from the central valve stem, through the wetted packing material, extended bonnet shell, and insulation so that the wetted packing material is not able to freeze.

The valve must balance several competing requirements and is therefore the most sensitive component in a high temperature piping network when it comes to freeze risk. Valves are typically actuated electrically, pneumatically, or hydraulically depending on their size and this actuation mechanism must be kept near ambient temperature. The valve body and stem, however, must be kept at temperatures above the freezing temperature of the fluid flowing through the valve. Finally, the valve steam must be sealed against the valve bonnet in order to contain the fluid flowing through the valve. This is typically done with a valve stem packing material such as graphite or by welding a bellows between the valve stem and bonnet. However, this sealing element often cannot tolerate the same temperatures as the valve body itself. These conditions therefore lead to the need for an extended bonnet to separate the valve into different temperature regions based on axial conduction of heat from the valve body up through the stem and bonnet to the actuation joint, where there is a sharp transition in temperature due to natural convection at the base of the extended bonnet. However, by relying only on conduction the specific temperatures throughout the valve along the axis of the valve stem can vary with operating and ambient conditions especially when the valve is closed and risks freezing the fluid within the packing material or bellows seal. Thawing this frozen fluid or actuating the valve while frozen typically destroys the valve seal and potentially the valve stem itself, therefore requiring some way to avoid freezing fluid within the sealing region.

In an embodiment, the valve is used to control a working fluid, such as a molten salt. In an embodiment, the molten salt system may be a primary or secondary coolant or thermal storage media for a concentrating solar power electrical generating plant, nuclear power plant, or grid-tied thermal storage system.

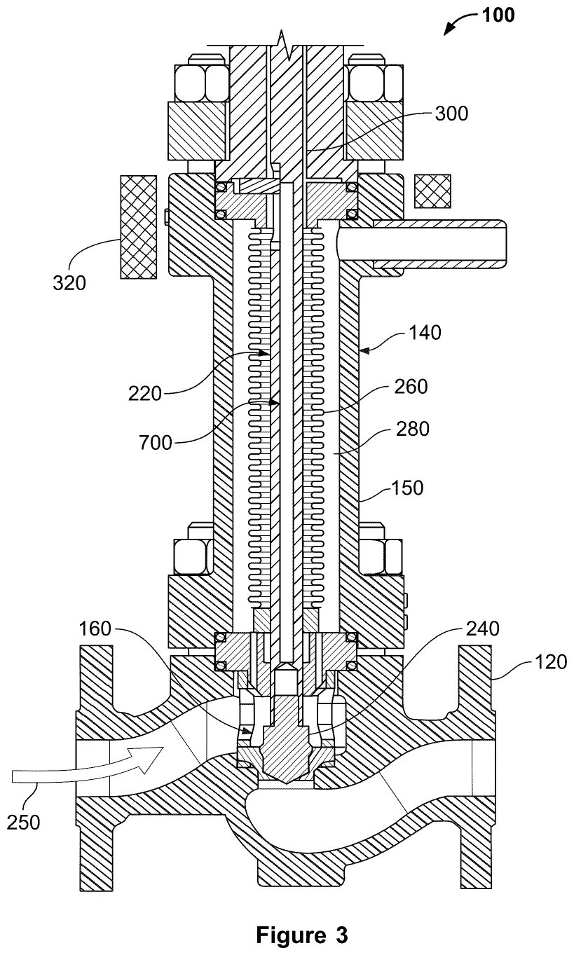

FIG. 3 shows a bellows-sealed valve (bellows valve) 100 according to an embodiment of the disclosure. The bellows valve 100 includes a valve body 120 and extended bonnet 140. The valve body 120 includes a seat 160. The extended bonnet 140 includes a bonnet body 150. Disposed within the extended bonnet 140 is valve stem 220 that includes a plug 240. In FIG. 3, the valve stem 220 is lowered and in a closed valve position that brings the plug 240 in contact with the seat 160 of the valve body 120. In this position, a fluid flow indicated by the arrow 250 is stopped at the plug 240 from continuing to flow through the valve body 120. Within the bonnet body 150 is a bellows 260 that surrounds the valve stem 220. Between the bellows 260 and the bonnet body 150 is bonnet space 280. The bellows 260 prevents fluids including gases, vapors and liquids that have leaked past the valve stem 220 and into the bonnet space 280 from leaking past the stem 220 into any upper valve space 300. The bellows 260 allows the valve stem 220 to translate up to bring plug 240 out of the valve seat 160 and open a flow path in the valve body 120 while still preventing leakage into the upper valve space 300. Optional heat tape 320 may further be used to prevent fluids from freezing in the upper valve space 300. In other embodiments, other optional heating devices and systems may be used, such as but not limited to fluid heating jackets, heat tape, radiant heaters, etc.

As can be seen in FIG. 3, the valve stem 220 includes a heat pipe 700. The heat pipe 700 is a space or chamber formed within the valve stem 220 and containing a heat pipe working fluid. The heat pipe 700 is sealed or self-contained in the stem 220. In an embodiment, the heat pipe 700 may include a closed tube filled the heat pipe working fluid, such as, but not limited to an alkali metal that is disposed in the space or chamber. For example, a space may be drilled or machined into the valve stem, the working fluid added, and the space plugged or sealed. In another example, a tube is used for the hollow section of the valve stem and welded, brazed, or otherwise attached to the rest of the valve stem. The space may be sleeved with a material different from the valve stem material. The heat pipe 700 includes a working fluid in an amount sufficient to prevent dry out of the evaporator at the maximum operating temperature. In an embodiment, the amount of fluid may be between 5 and 95% by volume of the heat pipe. In another embodiment, a bulb or reservoir may be attached to the heat pipe to create a variable conductance heat pipe so that working fluid inventory or amount could be transferred to or from the heat pipe to control the saturation pressure and therefore operating temperature of the heat pipe.

The heat pipe working fluid is a fluid that can exist as both a liquid and gas at the required operating temperature. For high temperature applications (temperature>300° C.), liquid metals such as, but not limited to mercury, cesium, potassium, sodium, lithium, rubidium, silver, or sodium-potassium eutectic (NaK). For lower-temperature applications (temperature<300° C.), organic and other fluids may be used, such as, but not limited to water, toluene, alcohols, thermal oils, etc.

In an embodiment, the working fluid may be solid at ambient or near ambient temperatures but in a two-phase condition at valve operating temperatures. In an embodiment, the working fluid may be the same composition as the fluid flowing through the valve but sealed to operate at a different pressure and therefore a different saturation temperature such as would be necessary for a liquid sodium flow system.

When a hot system fluid is present in or flowing through the valve body 120, heat is transferred to the valve stem 220 and heat pipe 700. As the working fluid of the heat pipe increases in temperature, it vaporizes to fill the heat pipe chamber and transfer heat to the axial length of the valve stem 220. In such a manner, the heated valve stem 220 can heat the bellows 260 to heat any system fluid that has leaked past the stem 220 and into the space between the bellows 260 and the bonnet body 150 to prevent the leaked system fluid from freezing in the space. The system fluid may be any system fluid that may freeze under ambient conditions. In an embodiment, the system fluid may be a molten salt or other mixtures of compounds or pure elemental fluids.

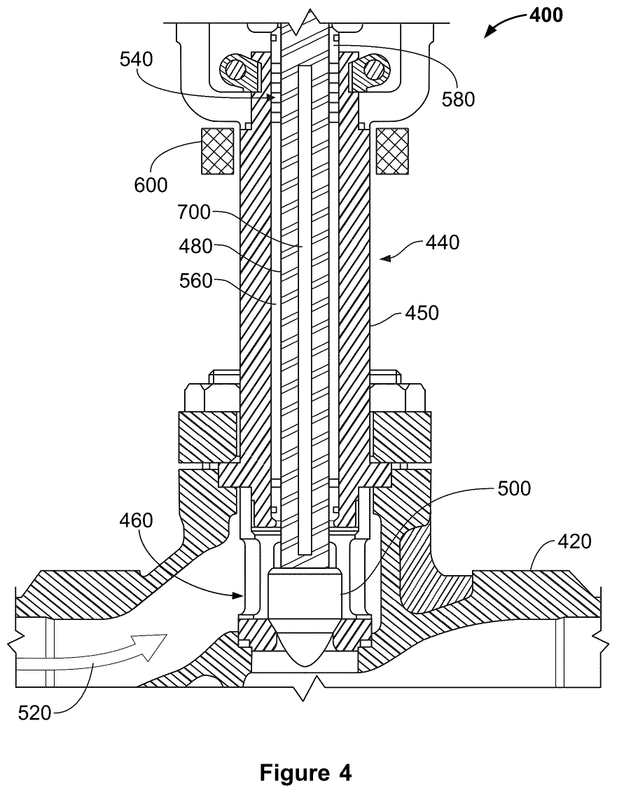

FIG. 4 shows a prior art packed valve 400. The packed valve 400 includes a valve body 420 and an extended bonnet 440. The valve body 420 includes a seat 460. The extended bonnet 440 includes a bonnet body 450. Disposed within the extended bonnet 440 is valve stem 480 that includes a plug 500. In FIG. 4, the valve stem 480 is lowered and in a closed valve position that brings the plug 500 in contact with the valve seat 460 of the valve body 420. In this position, a fluid flow indicated by the arrow 520 is stopped at the plug 500 from continuing to flow through the valve body 420. Within the extended bonnet 440, packing 540 surrounds the valve stem 480. Between the valve stem 480 and bonnet body 450 is bonnet space 560. The packing prevents fluids including gases, vapors and liquids that have leaked past the valve stem 480 and into the bonnet space 560 from leaking past the stem 480 into any upper valve space 580. Optional heat tape 600 may be used to further prevent fluids from freezing in the upper valve space 580. In other embodiments, other optional heating devices and systems may be used, such as but not limited to fluid heating jackets, heat tape, radiant heaters, etc.

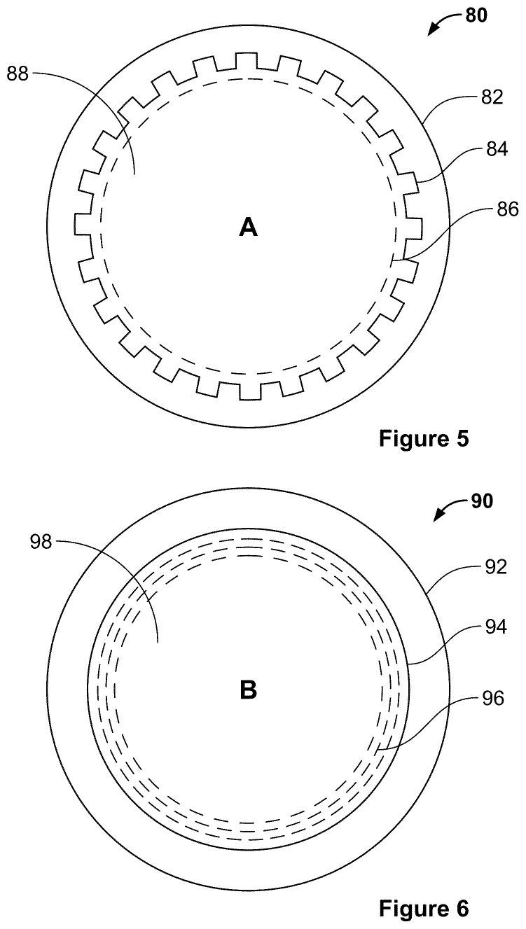

FIG. 5 shows a heat pipe 80 according to another embodiment of the disclosure. As can be seen in FIG. 5, the heat pipe 80 includes a valve stem 82, an inner wall 84 defining a chamber A, a screen 86 disposed adjacent the inner wall 84, and a heat pipe working fluid 88. In this exemplary embodiment, the inner wall 84 is an inner surface of a valve stem. In another embodiment, the inner wall 84 may be a metal sleeve that abuts the inner surface of a valve stem.

The screen 86 is disposed along all or part of the axial length of the heat pipe 80 in contact with the inner wall 84. In this exemplary embodiment, the screen 86 has a nominal pore radius of 0.0015 inches. In other embodiments, the pore radius may vary based on the working fluid and operating conditions. In such a manner, the screen 86 facilitates wicking the working fluid, present as a liquid in the grooves of the heat pipe, from the condenser section back to the evaporator opposite to the flow of the vapor in the vapor space from the evaporator to the condenser.

Additionally, in this embodiment, the inner wall 84 is grooved to provide a flow path beneath the screen with a low hydraulic resistance thus increasing the capillary pump capability of the heat pip. In this exemplary embodiment, there are 20 grooves evenly spaced around the circumference of the heat pipe that are 0.008 inches deep by 0.008 inches wide. In other embodiments, the dimensions and geometry of the grooves may be modified for the working fluid and operating conditions. In an embodiment, the grooves may have a cross-section, such as, but not limited to square, rectangular, triangular, and partial circular. In other embodiments, the inner wall 84 may be smooth or have other surface features such as, but not limited to grooves of different cross-sections such as triangular, sections of a circle, or some other shape. Furthermore, in this exemplary embodiment, the screen 86 is a single layer, but in other embodiments, multiple layers of screen material may be used.

In this exemplary embodiment, the screen 86 is a woven 250 mesh steel screen. In other embodiments, the screen 86, which is a wicking device, may be an etched screen, slotted screen, felted metal, sintered powder, woven screen, etched screen, slotted screen, felted metal (see the embodiment shown in FIG. 6 and described below), sintered powder, or combinations of several porous structures including those with graded porosity and with or without arterial channels, or combinations of several porous structures including those with graded porosity as small pores are desirable at the inner surface of the screen to increase capillary forces and large pores are desirable along the inner wall of the heat pipe to reduce resistance to liquid flow.

FIG. 6 shows a heat pipe 90 according to another embodiment of the disclosure. As can be seen in FIG. 6, the heat pipe 90 includes a valve stem 92, an inner wall 94 defining a chamber B, a metal felt 96 disposed adjacent the inner wall 94, and a heat pipe working fluid 98. In this exemplary embodiment, the inner wall 94 is an inner surface of a valve stem. In another embodiment, the inner wall 94 may be a metal sleeve that abuts an inner surface of a valve stem. Also, in this exemplary embodiment, the inner wall 94 is smooth, however in other embodiments, the inner wall 94 maybe slotted or grooved.

In this exemplary embodiment, the metal felt 96 is matted from stainless steel wire and has a thickness of 0.008 inches and a nominal pore radius of 0.0015 inches. In other embodiments, the features of the metal felt may vary based on the working fluid and operational parameters. The metal felt 96 provides high capillary pumping of the working fluid axially in the chamber B. In other embodiments, the metal felt 96 may be replaced by sintered ceramic, metal or cermet powder, felted wire or other porous media with or without arterial channels to reduce liquid flow resistance as one skilled in the design of heat pipes can readily appreciate. In another embodiment, a varied porosity or arterial wick design rather than a constant porosity wick may be used to reduce the pressure drop of the condensed liquid within the heat pipe and increase the conductance of the heat pipe if needed.

It should be noted that although the figures herein may show a specific order of method steps, it is understood that the order of these steps may differ from what is depicted. Also, two or more steps may be performed concurrently or with partial concurrence. Such variation will depend on the software and hardware systems chosen and on designer choice. It is understood that all such variations are within the scope of the application.

1. A valve, comprising:
a valve bonnet;
a valve stem having a length disposed within the valve bonnet, the valve stem comprising an internal chamber comprising an interior wall that extends axially along part of the length of the valve stem;
a valve body comprising a flow passage and a valve seat into which the valve stem extends when the flow control valve is in a closed position thereby stopping flow of a system fluid through the valve body; and
a heat transfer medium disposed in the chamber;
wherein the heat transfer medium is a fluid at a selected operating temperature of the flow control valve.

2. The valve of claim 1, wherein a wicking device is disposed within the internal chamber.

3. The valve of claim 2, wherein the wicking device is selected from the group consisting of a woven screen, etched screen, slotted screen, felted metal, sintered powder, or combinations of several porous structures including those with graded porosity and with or without arterial channels.

4. The valve of claim 2, wherein grooves are formed in the interior wall of the valve stem to increase liquid flow capacity.

5. The valve of claim 4, wherein the grooves have a cross-section selected from the group consisting of a square, rectangular, triangular, and partial circular cross-sections.

6. The valve of claim 1, wherein the heat transfer material when solid or liquid fills between 5% and 95% of the internal chamber by volume.

7. The valve of claim 1, further comprising a bellows around the valve stem for sealing the system fluid within the flow control valve.

8. The valve of claim 1, further comprising packing around the valve stem for sealing the system fluid within the flow control valve.

9. The valve of claim 1, wherein the heat transfer medium is selected from the group consisting of mercury, cesium, potassium, sodium, lithium, rubidium, silver, and sodium-potassium eutectic.

10. The valve of claim 1, wherein the heat transfer medium is selected from the group consisting of water, water/salt mixtures, and organic fluids.
